(19) United States
(12) Patent Application Publication
(10) Pub. No.: US 2012/0158884 A1
(43) Pub. Date: Jun. 21, 2012

(54) CONTENT DISTRIBUTION DEVICE, CONTENT DISTRIBUTION METHOD, AND PROGRAM

(75) Inventor: Hiroyuki Hatano, Tokyo (JP)

(73) Assignee: NEC CORPORATION, Minato-ku, Tokyo (JP)

(21) Appl. No.: 13/392,804

(22) PCT Filed: Aug. 27, 2010
(86) PCT No.: PCT/JP2010/064591

§ 371 Date: Feb. 27, 2012

(30) Foreign Application Priority Data
Aug. 31, 2009 (JP) 2009-200382

(51) Int. Cl. G06F 15/167

(52) U.S. Cl. 709/213

(57) ABSTRACT

A content distribution device of the present invention includes: a content holding unit that holds a plurality of distribution contents that can be distributed, the distribution content including a first content that has a first bit rate and a second content that has a second bit rate lower than the first bit rate; a cache holding unit that temporarily holds at least one of the first and second contents; a cache control unit that reads out the first or second content to be distributed from the content holding unit, and stores the read out content in the cache holding unit; and a content distribution unit that reads out and distributes the first or second content that is temporarily held in the cache holding unit, or the first or second content that is held in the content holding unit, in distribution of a specified content specified by a distribution request among the plurality of distribution contents. The content distribution unit reads out and distributes the second content of the specified content that is held in the content holding unit, in a case of the specified content not being stored in the cache holding unit, and an available capacity of the cache holding unit being less than a first available capacity threshold value.

### TECHNICAL FIELD

The present invention relates to a system that distributes content such as movies and the like. The present invention in particular relates to a content distribution device, a content distribution method, and a program that temporarily hold content in a cache memory, and read out the content from the cache memory.

### BACKGROUND ART

In a content distribution system that distributes video content such as movies and dramas via a network, a cache technology is utilized that stores the content in a cache memory and distributes the content from the cache memory. With this technology, the number of access hits to a disk device that stores the content is reduced, which improves the distribution performance. In content distribution that utilizes cache memory, since the size of the memory that caches the content is small with respect to the size of the disk device, efficient utilization of the cache region is necessary.

One example of a method of efficiently utilizing the cache region is disclosed in Patent Document 1. The method that is disclosed in Patent Document 1 secures a region for storing content to a cache memory by deleting in block units the data of content that can be deleted in the cache memory, in the case of the cache memory having entered a full state.

### PRIOR ART DOCUMENT

### Patent Document

[Patent Document 1] Japanese Unexamined Patent Application, First Publication No. 2001-313919

### SUMMARY OF THE INVENTION

### Problem to be Solved by the Invention

However, there have been the following issues in the related art disclosed in Patent Document 1.

In the case of all of the blocks that are stored in the cache memory being accessed, it is not possible to secure a free region for newly storing data by deleting data in the cache memory. For this reason, since it is not possible to store content in the cache memory, the content that is not stored in the cache memory is distributed by reading out the content from the disk device. In the state in which content cannot be stored in this cache memory, when distribution requests increase for the content that is not stored in the cache memory, the number of distributions that involve reading out and distributing content from the disk device increases, and reaches the access limit of the disk device. When the access limit of the disk device is reached, the problem arises of the content distribution system no longer being capable of content distribution, and so the service stops.

The reason for that is as follows. In the content distribution system that utilizes a cache memory, by performing distribution utilizing the cache memory, it is possible to reduce the access band to the disk device. For this reason, compared with the upper limit value of a simultaneous distribution band of a content distribution system, reducing the upper limit of the simultaneous access band to a disk device holds down the costs associated with the disk device of a content distribution system. For this reason, in the case of the cache memory becoming full, there is no content that can be deleted, and when the number of processes of distributing content by accessing the disk device increases, the upper limit of the access band to the disk device is reached prior to reaching the simultaneous distribution band of the content distribution system.

The present invention has been conceived in view of such circumstances. An object of the present invention is to provide a content distribution device, a content distribution method and a program that, in a content distribution system that utilizes a cache memory, can continue a content distribution service without lowering the number of simultaneous distributions of content, even in the case of the cache memory entering a state of being completely used, and content being read out and distributed from the disk device when it is not possible to secure available capacity by deleting cache memory.

### Means for Solving the Problem

In order to solve the aforementioned issues, a content distribution device according to a first exemplary aspect of the present invention includes: a content holding unit that holds a plurality of distribution contents that can be distributed, the distribution content including a first content that has a first bit rate and a second content that has a second bit rate lower than the first bit rate; a cache holding unit that temporarily holds at least one of the first and second contents; a cache control unit that reads out the first or second content to be distributed from the content holding unit, and stores the read out content in the cache holding unit; and a content distribution unit that reads out and distributes the first or second content that is temporarily held in the cache holding unit, or the first or second content that is held in the content holding unit, in distribution of a specified content specified by a distribution request among the plurality of distribution contents. The content distribution unit reads out and distributes the second content of the specified content that is held in the content holding unit, in a case of the specified content not being stored in the cache holding unit, and an available capacity of the cache holding unit being less than a first available capacity threshold value.

A content distribution device according to a second exemplary aspect of the present invention includes: a content holding unit that holds a plurality of distribution contents that can be distributed, the distribution content including a first content that has a first bit rate and a second content that has a second bit rate lower than the first bit rate; a cache holding unit that temporarily holds at least one of the first and second contents; a cache control unit that reads out the first or second content to be distributed from the content holding unit, and stores the read out content in the cache holding unit; and a content distribution unit that reads out and distributes the first or second content that is temporarily held in the cache holding unit, or the first or second content that is held in the content holding unit, in distribution of a specified content specified by a distribution request among the plurality of distribution contents. The content distribution unit reads out and distributes the second content of the specified content that is held in the content holding unit, in a case of the specified content not being stored in the cache holding unit, and total of access bands in which the cache control unit and the content distribution unit respectively read out the first or second content from the content holding unit being equal to or greater than an access band threshold value.

A content distribution method according to a third exemplary aspect of the present invention for a content distribution device, includes: holding in a content holding unit of the content distribution device a plurality of distribution contents that can be distributed, the distribution content including a first content that has a first bit rate and a second content that has a second bit rate lower than the first bit rate; temporarily holding at least one of the first and second contents in a cache holding unit of the content distribution device; reading out the first or second content to be distributed from the content holding unit, and storing the read out content in the cache holding unit, by a cache control unit of the content distribution device; and reading out and distributing the second content of a specified content that is held in the content holding unit by a content distribution unit of the content distribution device, in a case of the specified content that is specified by the distribution request among the plurality of distribution contents not being stored in the cache holding unit, and an available capacity of the cache holding unit being less than a first available capacity threshold value.

A content distribution method according to a fourth exemplary aspect of the present invention for a content distribution device, includes: holding in a content holding unit of the content distribution device a plurality of distribution contents that can be distributed, the distribution content including a first content that has a first bit rate and a second content that has a second bit rate is lower than the first bit rate; temporarily holding at least one of the first and second contents in a cache holding unit of the content distribution device; reading out the first or second content to be distributed from the content holding unit, and storing the read out content in the cache holding unit, by a cache control unit of the content distribution device; and reading out and distributing the second content of a specified content that is held in the content holding unit by a content distribution unit of the content distribution device, in a case of a specified content specified by the distribution request among the plurality of distribution contents not being stored in the cache holding unit, and total of access bands in which the cache control unit and the content distribution unit respectively read out the first or second content from the content holding unit being equal to or greater than an access band threshold value.

A program according to a fifth exemplary aspect of the present invention for a computer of a content distribution device including a content holding unit that holds a plurality of distribution contents that can be distributed, the distribution content including a first content that has a first bit rate and a second content that has a second bit rate lower than the first bit rate, and a cache holding unit that temporarily holds at least one of the first and second contents, causes the computer to function as: a cache control unit that reads out the first or second content to be distributed from the content holding unit, and stores the read out content in the cache holding unit; and a content distribution unit that reads out and distributes the second content of a specified content that is held in the content holding unit in a case of a specified content that is specified by the distribution request among the plurality of distribution contents not being stored in the cache holding unit, and an available capacity of the cache holding unit being less than a first available capacity threshold value.

A program according to a sixth exemplary aspect of the present invention for a computer of a content distribution device including a content holding unit that holds a plurality of distribution contents that can be distributed, the distribution content including a first content that has a first bit rate and a second content that has a second bit rate lower than the first bit rate, and a cache holding unit that temporarily holds at least one of the first and second contents, causes the computer to function as: a cache control unit that reads out the first or second content to be distributed from the content holding unit, and stores the read out content in the cache holding unit; and a content distribution unit that reads out and distributes the second content of a specified content that is held in the content holding unit, in a case of the specified content that is specified by the distribution request among the plurality of distribution contents not being stored in the cache holding unit, and total of access bands in which the cache control unit and the content distribution unit respectively read out the first or second content from the content holding unit being equal to or greater than an access band threshold value.

### Effect of the Invention

According to an exemplary embodiment of this invention, in content distribution that utilizes a cache holding unit that caches content, since an increase in the access band to a disk device is suppressed even in the case of the cache region being insufficient, and the access to the disk device having increased, it is possible to continue the content distribution.

### BRIEF DESCRIPTION OF THE DRAWINGS

FIG. 1 is a block diagram that shows the constitution of a content wiring system according to a first exemplary embodiment of the present invention.

FIG. 2 is a conceptual diagram that shows one example of a content information table according to the first exemplary embodiment of the present invention.

FIG. 3 is a conceptual diagram that shows one example of a content information table according to the first exemplary embodiment of the present invention.

FIG. 4 is a flowchart for describing the operation of the process of storing content according to the first exemplary embodiment of the present invention.

FIG. 5 is a conceptual diagram that shows one example of the content information table that is registered by a content registration unit, according to the first exemplary embodiment of the present invention.

FIG. 6 is a conceptual diagram that shows one example of the cache control table immediately after being registered by the content registration unit, according to the first exemplary embodiment of the present invention.

FIG. 7 is a sequence diagram for describing the operation of starting the distribution of content according to the first exemplary embodiment of the present invention.

FIG. 8 is a flowchart for describing the operation of starting the distribution of content according to the first exemplary embodiment of the present invention.

FIG. 9 is a flowchart for describing the operation of storing content data according to the first exemplary embodiment of the present invention.

FIG. 10 is a flowchart for describing the operation of the process of deleting cache data of content according to the first exemplary embodiment of the present invention.

FIG. 11 is a conceptual diagram that shows the constitution of a content information table according to a second exemplary embodiment of the present invention.

FIG. 12 is a conceptual diagram that shows an example of the content information table according to the second exemplary embodiment of the present invention.

FIG. 13 is a conceptual diagram that shows the constitution of a content information table according to a third exemplary embodiment of the present invention.

FIG. 14 is a conceptual diagram that shows one constitutive example of the content information table according to the third exemplary embodiment of the present invention.

FIG. 15A is a flowchart for describing the operation of distributing content according to the third exemplary embodiment of the present invention.

FIG. 15B is a flowchart for describing the operation of distributing content according to the third exemplary embodiment of the present invention.

FIG. 16 is a conceptual diagram that shows the constitution of a content information table according to a fourth exemplary embodiment of the present invention.

FIG. 17A is a flowchart for describing the operation of distributing content according to the fourth exemplary embodiment of the present invention.

FIG. 17B is a flowchart for describing the operation of distributing content according to the fourth exemplary embodiment of the present invention.

FIG. 18 is a conceptual diagram that shows one constitutive example of the content information table according to the fourth exemplary embodiment of the present invention.

### EMBODIMENTS FOR CARRYING OUT THE INVENTION

Hereinbelow, the first exemplary embodiment of the present invention shall be described with reference to the drawings.

### A. First Exemplary Embodiment

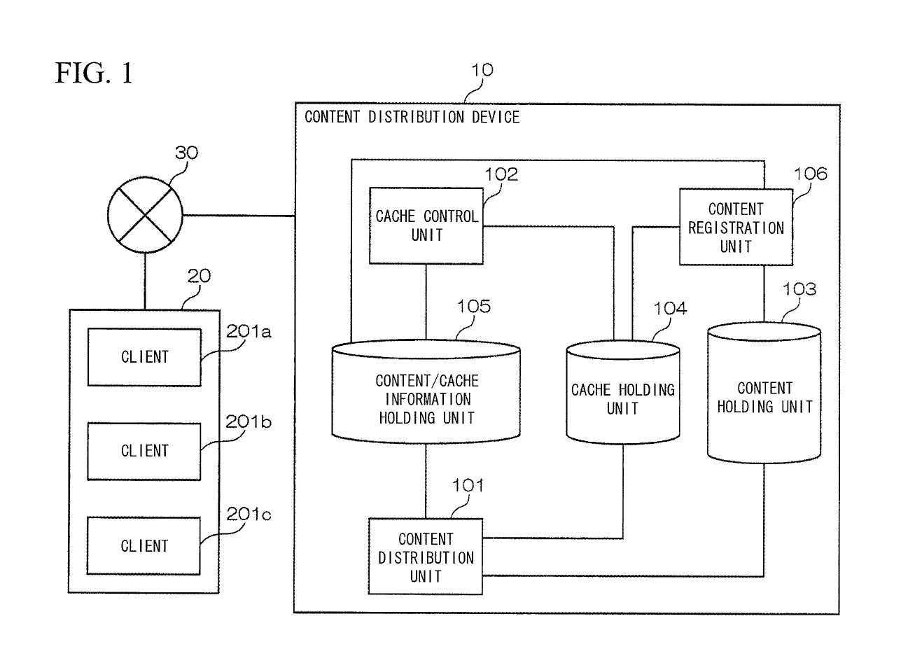

FIG. 1 is a block diagram that shows the configuration of a content distribution system according to a first exemplary embodiment of the present invention. In FIG. 1, the content distribution system is constituted from a content distribution device 10, a client group 20 that receives the content, and a network 30.

The content distribution device 10 includes a content distribution unit 101, a cache control unit 102, a content holding unit 103, a cache holding unit 104, a content/cache information holding unit 105, and a content registration unit 106.

The client group 20 is a terminal that receives content, and has a function for connecting to the network 30. In the present first exemplary embodiment, for the sake of convenience, the client group 20 shall be described as a constitution of three units, namely, a client terminal 201a, a client terminal 201b, and a client terminal 201c. However, there is no restriction on the number of client terminals in the client group 20.

The network 30 is a network such as the Internet that connects the content distribution device 10 and the respective client terminals 201a to 201c of the client group 20.

The function of each processing unit mentioned above shall be described.

The content distribution unit 101 receives a content distribution request from the respective client terminals 201a to 201c of the client group 20. In the case of the content whose distribution is requested being stored in the cache holding unit 104, the content distribution unit 101 reads out the content from the cache holding unit 104 and distributes the content to any of the client terminals 201a to 201c of the client group 20 that performed the content distribution request via the network 30.

At this time, in the case of the specified content not being stored in the cache holding unit 104, the content distribution unit 101 confirms the available capacity of the cache holding unit 104. In the case of the available capacity of the cache holding unit 104 being greater than a threshold value that has been set, the content distribution unit 101 instructs the cache control unit 102 to store the content in the cache holding unit 104. The content distribution unit 101 reads out that content that has been stored in the cache holding unit 104 by this instruction, and distributes the content to the respective client terminals 201a to 201c of the client group 20 via the network 30.

On the other hand, in the case of the available capacity of the cache holding unit 104 being less than a threshold value that has been set, in accordance with the setting of the content/cache information holding unit 105, the content distribution unit 101 reads out from the content holding unit 103 a file with a bit rate that is lower than a file that is read out in normal distribution, and distributes that file to the respective client terminals 201a to 201c of the client group 20 via the network 30.

The cache control unit 102, by the instruction of the content distribution unit 101, stores the content of the content holding unit 103 in the cache holding unit 104 in accordance with a cache control table 300 that is stored in the content/cache information holding unit 105. Also, the cache control unit 102 deletes in block units the cache of each content that is stored in the cache holding unit 104, in accordance with the access state with respect to the block of the content that is set in the cache control table 300 that is stored in the content/cache information holding unit 105.

The content holding unit 103 is a storage unit that stores content that can be distributed, and is realized by a storage device that is constituted from nonvolatile memory such as a magnetic disk or semiconductor memory. The content that is to be stored in the content holding unit 103 is for example video content such as Movies and dramas.

The cache holding unit 104 functions as a cache memory that temporarily stores content, and holds content that can be distributed in a region that is divided into a plurality of blocks. This cache holding unit 104 is realized by RAM (random access memory) or the like.

The content/cache information holding unit 105 holds, for each content, information relating to the content such as bit rate, file ID, and the like as a content information table 200. Also, the content/cache information holding unit 105 holds information that controls the cache memory for each content as the cache control table 300.

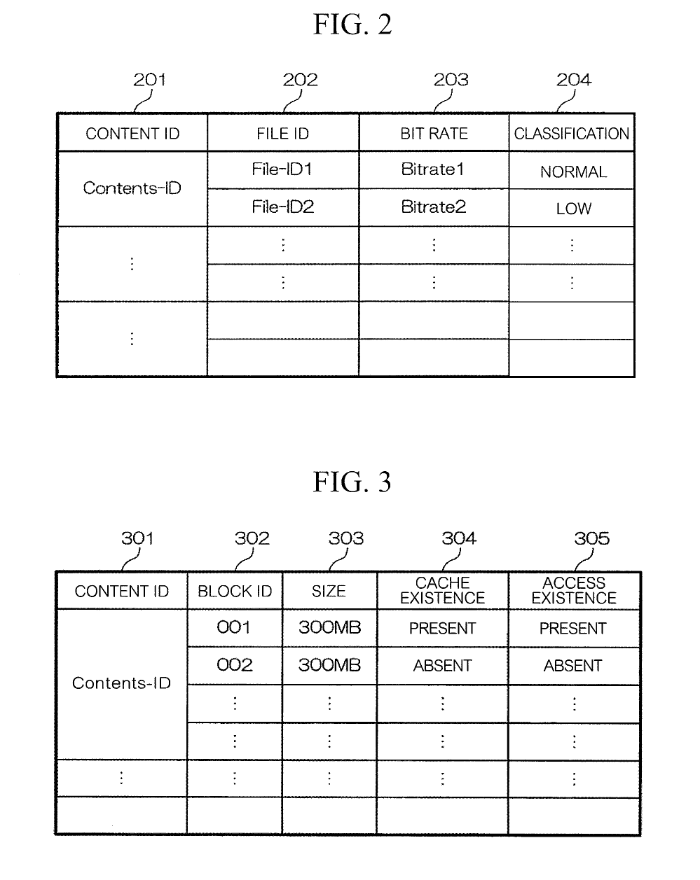

FIG. 2 is a conceptual diagram that shows one example of the content information table 200 according to the first exemplary embodiment. In the illustrated example, the content information table 200 is constituted from a content ID 201, a file ID 202, a bit rate 203, and a classification 204. The content ID 201 is an ID for identifying content that is given to each content. The file ID 202 is an ID that is given to every file, with respect to files of a plurality of differing bit rates that one content has. The bit rate 203 is information that indicates the bit rate that corresponds to the file ID 202. The classification 204 is information that indicates whether the file that corresponds to the file ID 202 is classified as being used in normal distribution (in this case, the classification is notated as “normal”), or classified as being used when the available capacity of the cache memory has fallen (in this case, the classification is notated as “low”).

FIG. 3 is a conceptual diagram that shows one example of the cache control table 300. In the illustrated example, the cache control table 300 is constituted from a content ID 301, a block ID 302, a size 303, a cache existence 304, and an access existence 305. The content ID 301 is an ID for identifying content that is given to each content, and is the same as the content ID 201 of the content information table 200. The block ID 302 is an ID that is given to every block in the case of one content being divided into a plurality of blocks, and the cache control information is set for each block ID 302. The size 303 is information that indicates the data size of the block ID 302. The cache existence 304 is information that indicates whether or not the block of the content that corresponds to the block ID 302 has been stored in the cache holding unit 104. The access existence 305 is information that indicates whether or not the cache of the block ID 302 is being accessed.

The content registration unit 106, in the process of storing content in the content holding unit 103, generates the aforementioned content information table 200 from the information of the file ID, the bit rate, and the classification as information relating to the content, and registers it in the content/cache information holding unit 105.

Also, the content registration unit 106, in the process of storing content in the content holding unit 103, generates the aforementioned cache control table 300 based on rules that are set in advance (for example, a rule that sets the division of content into a fixed sized or prescribed time), and registers it in the content/cache information holding unit 105.

Next, the overall operation of the first exemplary embodiment shall be described in detail.

First, in the first exemplary embodiment, the operation shall be explained of the content registration unit 106 generating the content information table 200 and the cache control table 300 that the content/cache information holding unit 105 holds, in the process of storing content in the content holding unit 103.

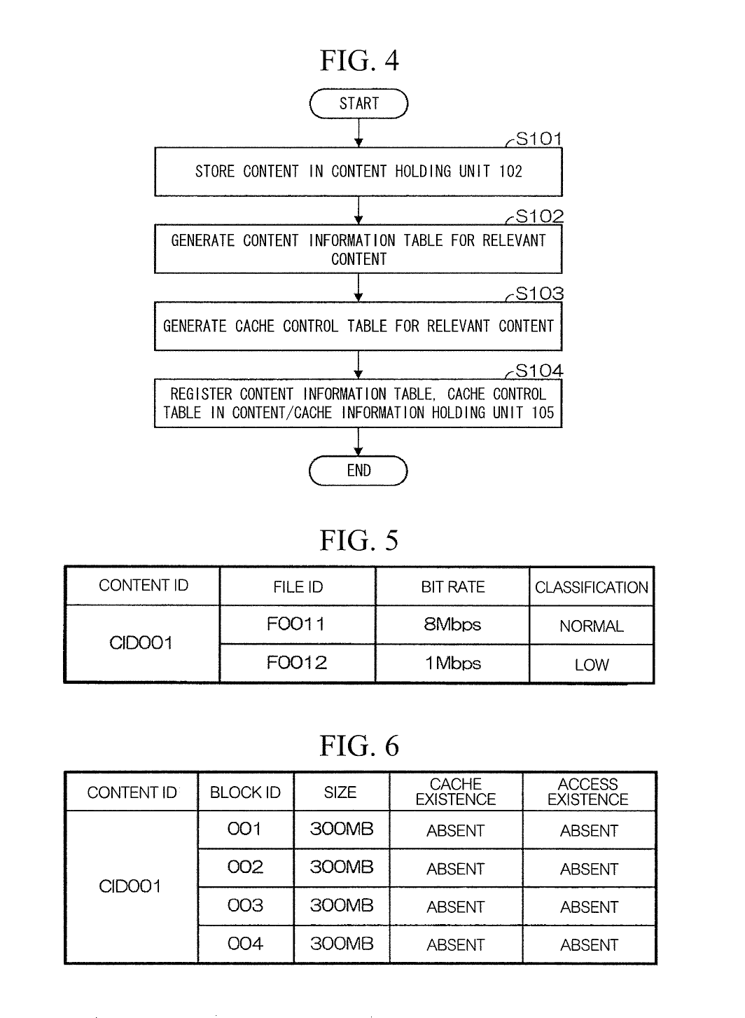

FIG. 4 is a flowchart for describing the operation of the process of storing content in accordance with the first exemplary embodiment. When content is stored in the content holding unit 102 (Step S101), a content information table 200 is generated for the content (Step S102), and moreover a cache control table 300 is generated for the content (Step S103). Next, the content generation unit 106 registers the content information table 200 and the cache control table 300 in the content/cache information holding unit 105 (Step S104).

In the generation of the content information table 200, the content registration unit 106 correspondingly registers the content ID 201 that identifies the stored content, the file ID 202 for a file with a bit rate used in normal distribution and a file with a low bit rate used when the cache memory available capacity has fallen below a set threshold value, the bit rate 203 for each file, and the classification 204 in the content information table 200.

In the generation of the cache control table 300, the content registration unit 106 correspondingly registers in the cache control table 300 the content ID 301 that identifies the stored content, the block ID 302 of each of the blocks that divide the content into a plurality of blocks based on a predetermined blocking rule, and the size 303 that shows the size of each block.

The content registration unit 106 correspondingly registers information of the initial value “absent” as the cache existence 304 and information of the initial value “absent” as the access existence 305 in the cache control table 300. The blocking rule indicates for example how to divide the content into a plurality of blocks when dividing content into a plurality of blocks to be stored in the cache holding unit 104 (content division method). For example, the data size of a block and playback time are specified as blocking rules.

With regard to this division, for example in the case of content (video) that is encoded at a fixed rate, since the data size and replay time uniquely correspond, if the content is divided every fixed replay time, the size of each block will be the same. On the other hand, in the case of the content that is encoded at a variable rate, since the data size and replay time do not uniquely correspond, if the content is divided every fixed replay time, each block size will differ in accordance with the respective rate. Likewise, in the case of the content being divided at every fixed size, the playback time of each block will differ in accordance with the respective rate.

The content information table 200 shall be described.

FIG. 5 is a conceptual diagram that shows one example of the content information table 200 that is registered by the content registration unit 106. The content of “CID001” is registered as the file ID, and the file of 8 Mbps for normal distribution is registered with the file ID of “F0011”, and the file of a low bit rate of 1 Mbps that is used when the available capacity of the cache memory has fallen below a set threshold value is registered with the file ID of “F0012”, with “normal” and “low” being set as the respective classifications.

Next, the cache control table 300 shall be described.

FIG. 6 is a conceptual diagram that shows one example of the cache control table 300 immediately after being registered by the content registration unit 106. The content of the content ID “CID001” is divided into four blocks every 300 MB, and the block ID 302 (001 to 004), size 303 (300 MB), cache existence 304 (absent), and access existence 305 (absent) are set for each block. In this example, due to immediately after content registration, the content existence 304 is entirely set to “absent”, and the access existence 305 is entirely set to “absent”.

Next, the operation of the content distribution device 10 receiving a content distribution request from the client terminal 201a and starting the distribution of the content shall be described.

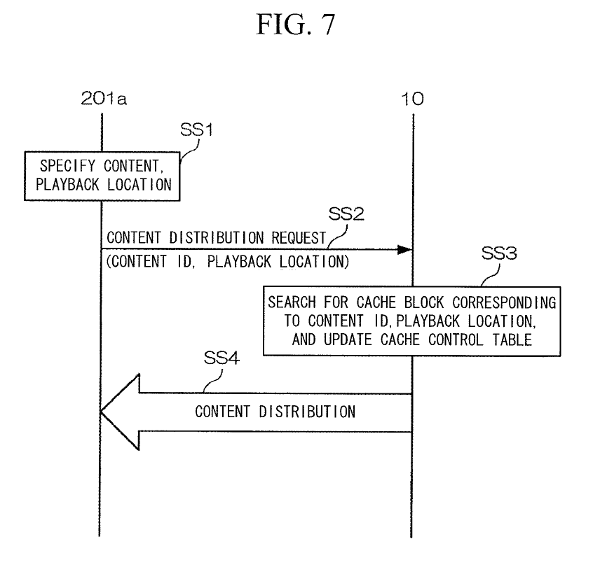

FIG. 7 is a sequence diagram for describing the operation of starting the distribution of content according to the first exemplary embodiment.

The client terminal 201a specifies the playback location of a content for which distribution has been requested (SS1), and performs a distribution request of the content by the content distribution device 10 (SS2). The content distribution device 10 that has received the content distribution request searches the cache control table 300 for the content that has been requested and the block that corresponds to the playback location, and reads out the block that corresponds to the playback location of the content that has been requested from the cache holding unit 104 or the content holding unit 103 to be distributed to the client terminal 201a, and updates the cache control table 300 (SS3, SS4). The playback location is for example the position that is specified by the playback time from the start of the content.

Next, the operation of the content distribution device 10 receiving a content distribution request from the client terminal 201a and starting the distribution of the content shall be described.

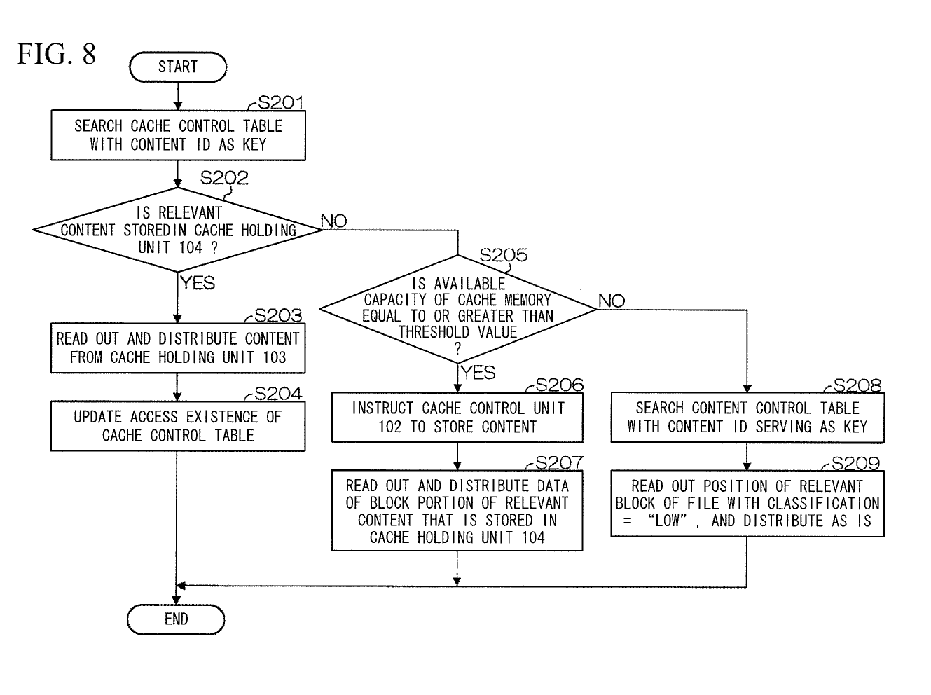

FIG. 8 is a flowchart for describing the operation of starting the distribution of content. The content distribution unit 101 of the content distribution device 10, upon receiving a content distribution request from the client terminal 201a, searches the cache control table 300 in the content/cache information holding unit 105, with the content ID specified for distribution and playback location serving as keys (Step S201). The content distribution unit 101 judges whether or not the data of the block portion is stored in the cache holding unit 104 based on the information of the cache existence that is registered in a corresponding manner with the ID of the block that corresponds to the specified playback location of the requested content (Step S202). As for the judgment of the block that corresponds to the specified playback location of the requested content, for example, in the case of the block being divided into units of the same time, the block that is reached first at the specified time of the requested content by adding the time unit in that playback sequence from the block that is played first based on the time unit in which each block is divided should be judged as the block that corresponds to the playback location of the specified time.

In the case of the data of the block portion of the content being stored in the cache holding unit 104 (that is, in the case of the information of the cache existence that is registered in correspondence with the ID of the block that corresponds to the specified playback location of the requested content showing “present”), the content distribution unit 101 reads out the data of the block portion of the relevant content from the cache holding unit 104, and distributes that data to the client terminal 201a (Step S203). Then, if the access existence 305 of the block that belongs to the content of the cache control table 300 in the content/cache information holding unit 105 is “absent”, the content distribution unit 101 updates it to “present” (Step S204).

On the other hand, in the case of the data of the block portion of the content not being stored in the cache holding unit 104 (that is, in the case of the information of the cache existence that is registered in correspondence with the ID of the block that corresponds to the specified playback location of the requested content showing “absent”), the content distribution unit 101 judges whether or not the available capacity of the cache memory is equal to or greater than the set threshold value (Step S205). If the available capacity of the cache memory is equal to or greater than the set threshold value, the content distribution unit 101 instructs the cache control unit 102 to notify the cache holding unit 104 of the ID of the block of the content, and to store the data of that block portion (Step S206). Next, the content distribution unit 101 reads out the data of the block portion of the content that is stored in the cache holding unit 104 by the instruction of Step S206, and distributes that data to the client terminal 201a (Step S207).

On the other hand, in the case of the available capacity of the cache memory being less than the threshold value, the content distribution unit 101 searches the content information table 200 in the content/cache information holding unit 105 with the content ID serving as a key (Step S208). The content distribution unit 101 selects the file in which the classification of the content is set to “low”, reads out the data of the block portion of that file from the content holding unit 103, and distributes that data to the client terminal 201a (Step S209).

The available capacity threshold value of the cache memory is a value that is set in advance by a set file or the like of the content distribution device 10, and the range thereof is set so that the minimum value is 0 and the maximum value takes a value of cache memory capacity. For example, in the case of the cache memory available capacity threshold value being set to 1 Gigabyte, the block of the content to be distributed is not stored in the cache memory, and when the available capacity of the cache memory falls below 1 Gigabyte, a file with a classification of “low” is read out and distributed, and the access band to the disk device is made smaller. For example, only in the case of the cache memory available capacity threshold value being 0, the file with the classification of “low” may be read out and distributed.

Next, the process of the cache control unit 102 storing content data in the cache holding unit 104 based on instruction from the content distribution unit 101 shall be described.

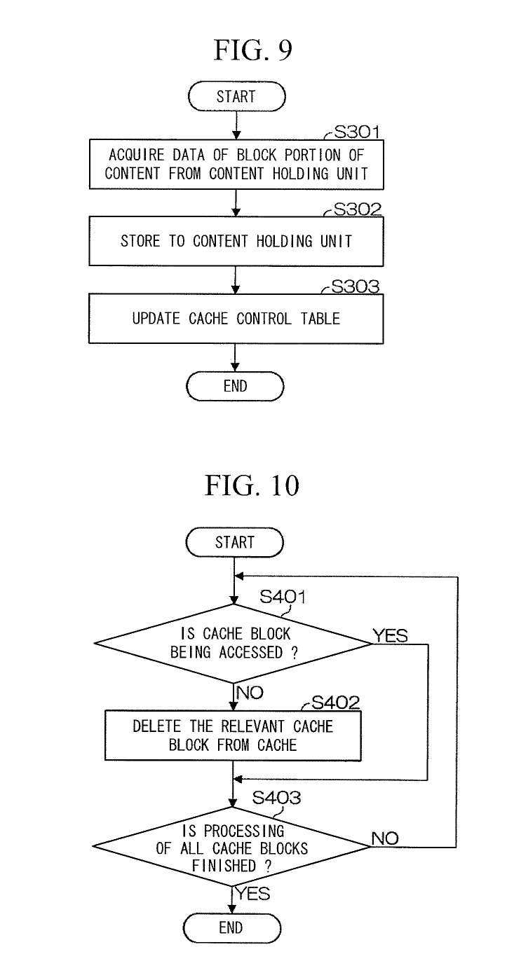

FIG. 9 is a flowchart for describing the operation of storing content data. The cache control unit 102, upon receiving a cache storing instruction from the content distribution unit 101, acquires data of the block portion of that content from the content holding unit 103 based on the block ID of the content whose notification was received (Step S301), stores that data in the cache holding unit 104 (Step S302), and updates the cache control table 300 (Step S303). That is to say, the cache control unit 102 updates the information of the cache existence 304 of the relevant block of the cache control table 300 from “absent” to “present”.

Next, the process of the cache control unit 102 deleting cache data of content that is stored in the cache holding unit 104 shall be described.

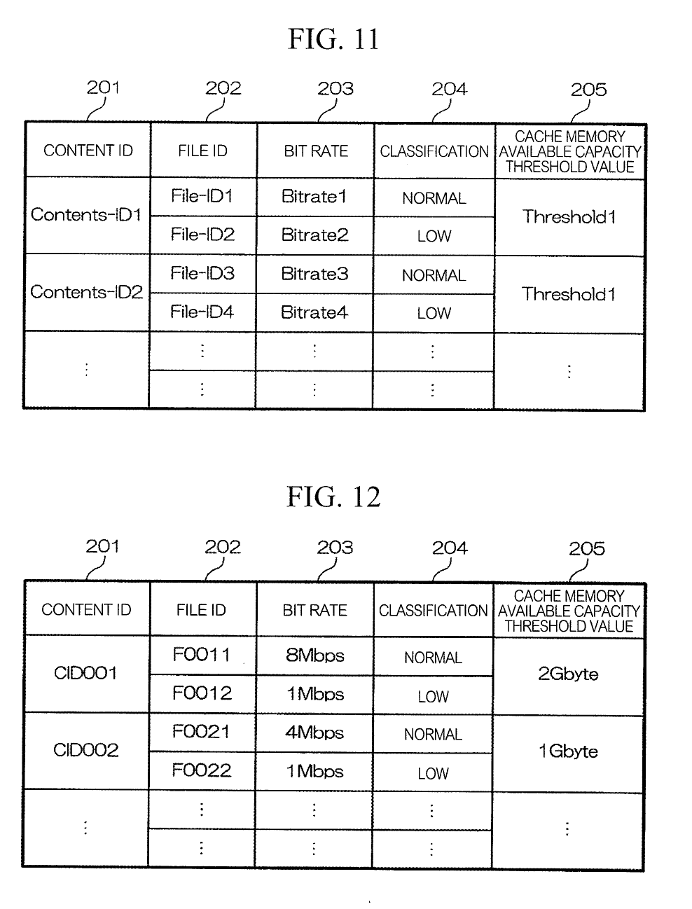

FIG. 10 is a flowchart for describing the operation of the process of deleting cache data of content according to the first exemplary embodiment. The cache control unit 102 refers to the cache control table 300 that is stored in the content/cache information holding unit 105 and confirms based on the access existence information whether or not the data that is cached in the cache holding unit 104 is being accessed (Step S401). In the case of the data that is cached being accessed (that is, in the case of access being “present”), the processing proceeds to Step S403 described below.

On the one hand, in the case of the data that is cached not being accessed (that is, in the case of access being “absent”), the cache control unit 102 deletes it from the cache holding unit 104, and sets the cache existence of the relevant content ID, block ID of the cache control table 300 to “absent” (Step S402).

Next, in the case of data that is cached in Step S401 being accessed, or in the case of the process of Step S402 having been completed, a judgment is made as to whether the processing of all the blocks of the cache control table 300 has been completed (Step S403), and in the case of not being completed, the processes from Step S401 to Step S402 are carried out for the next content ID and block ID.

The cache control unit 102 completes the process of carrying out the aforementioned series of processes (Step S401 to Step S402) on all of the content IDs and block IDs that are registered in the cache control table 300. The aforementioned processing by the cache control unit 102 is periodically executed at a predetermined time interval such as every minute, so as to update the cache control table 300 and the cache data of the cache holding unit 104.

According to the aforementioned first exemplary embodiment, by changing the bit rate of content that is distributed in accordance with the cache memory available capacity, it is possible to change the access band to the content holding unit 103. Thereby, even in the case where by an increase in distribution requests to the content distribution device 10, the content storage number to the cache holding unit 104 increases, leading to a state of the available capacity of the cache memory becoming insufficient, and as a result of content no longer being able to be stored in the cache memory, so that the access number to the content holding unit 103 increases, it is possible to inhibit an increase of the access band of the content holding portion 103, by lowering the bit rate of the content that is read out from the content holding portion 103 and distributed.

### B. Second Exemplary Embodiment

Next, a second exemplary embodiment of the present invention shall be described.

Since the constitution of the content distribution system and the content distribution device 10 according to the second exemplary embodiment is the same as the constitution of the first exemplary embodiment shown in FIG. 1, descriptions thereof shall be omitted.

FIG. 11 is a conceptual diagram that shows the constitution of a content information table 200 according to the second exemplary embodiment. The difference between the second exemplary embodiment and the first exemplary embodiment is that in the second exemplary embodiment, a cache memory available capacity threshold value 205 is added to the content information table 200, and the cache memory available capacity threshold value 205 is set in content ID units.

Next, the operation of generating the content information table 200 in the second exemplary embodiment shall be described. The generation of the content information table 200 is carried out in the process of the content registration unit 106 registering content, and similarly to the first exemplary embodiment, is processed in accordance with the flowchart shown in FIG. 4. The difference between the second exemplary embodiment and the first exemplary embodiment is the processing in Step S102 of FIG. 4, which is described below.

In the generation of the content information table 200 (Step S102 of FIG. 4), the content registration unit 106 registers the content ID 201 that identifies the stored content, the file ID of the file with the bit rate that is used in normal distribution, the classification thereof, and the bit rate when distributing that file in a corresponding manner in the content information table 200. Also, the content registration unit 106 registers in the content information table 200 the file ID of the file with a low bit rate that is used in the case of the cache memory available capacity falling below the set threshold value, the classification thereof, and the bit rate when distributing that file in a corresponding manner. Moreover, the content distribution unit 106 registers the cache memory available capacity threshold value 205 for judging whether to utilize the file of the normal bit rate or the low bit rate in correspondence with that information.

FIG. 12 is a conceptual diagram that shows one example of the content information table 200 according to the second exemplary embodiment.

In FIG. 12, the two contents of CID001 and CID002 are registered as content IDs in the content information table 200. The bit rate during normal distribution is 8 Mbps in the content of CID001, and 4 Mbps in the content of CID0012. The cache memory available capacity threshold value 205 is set for each content. The cache memory available capacity threshold value 205 is 2 Gigabytes in the content of CID001, and 1 Gigabyte in the content of CID0012.

Next, the operation of distributing content in the second exemplary embodiment shall be described.

The content distribution process according to the second exemplary embodiment is the same as the first exemplary embodiment, and is processed in accordance with the flowchart shown in FIG. 8. The second exemplary embodiment and the first exemplary embodiment differ on the point of using the cache memory available capacity threshold value 205 that is set for each content ID in the content information table 200, and not the value that is specified by the set file of the content distribution device 10, for the cache memory available capacity threshold value that is used in Step S205, and preparing the cache memory available capacity threshold value 205 in accordance with the content to the distributed. That is to say, it differs on the point of, in the case of content to be distributed not being stored in the cache holding unit 104, making the cache memory available capacity threshold value that is used for the content distribution unit 101 determining the bit rate of the content that is read out from the content holding unit 103 a different value in accordance with the content to be distributed.

According to the aforementioned second exemplary embodiment, since it is possible to set the cache memory available capacity threshold value 205 in accordance with the bit rate of the content to be distributed, by setting a large cache memory available capacity threshold value 205 for content that requires a large access band to the content holding unit 103, that is to say, content with a high bit rate, it is possible to suppress the access band to the content holding unit 103 while suppressing an increase in the usage amount of the cache memory. Also, by setting a small cache memory available capacity threshold value 205 for content with a low bit rate, it is possible to distribute it as much as possible at the bit rate that is normally used.

### C. Third Exemplary Embodiment

Next, a third exemplary embodiment of the present invention shall be described.

The constitution of the content distribution system and the content distribution device 10 according to the third exemplary embodiment is the same as the constitution of the first exemplary embodiment shown in FIG. 1, and so descriptions thereof shall be omitted.

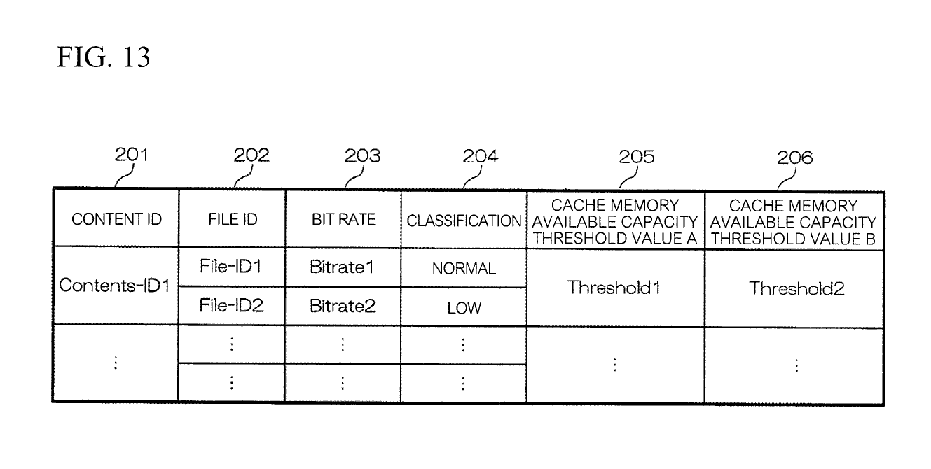

FIG. 13 is a conceptual diagram that shows the constitution of the content information table 200 according to the third exemplary embodiment.

The third exemplary embodiment differs from the aforementioned first and second exemplary embodiments on the point of having two cache memory available capacity threshold values in the content information table 200. The cache memory available capacity threshold value A205 is a value for switching from a bit rate when normally distributing content to be distributed to a low bit rate in the case of the cache memory available capacity amount falling below this value. The cache memory available capacity threshold value B206 is a value for switching to an operation that directly reads out the file with a low bit rate from the content holding unit 103 and distributes it without storing the content in the cache holding unit 104, in the case of the cache memory available capacity falling below this value.

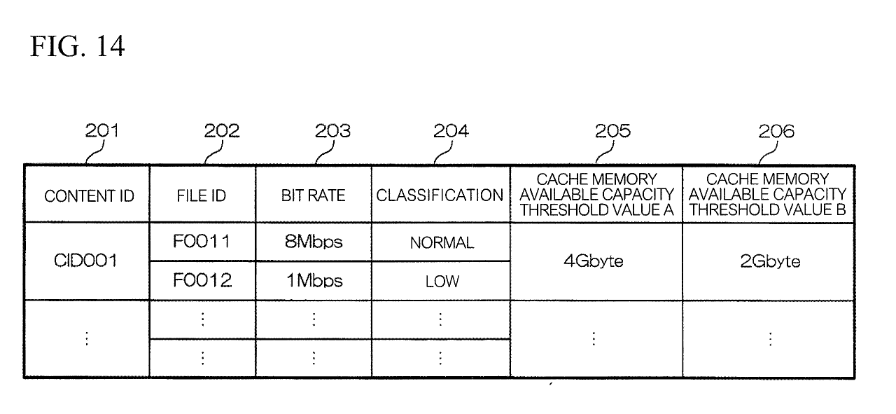

FIG. 14 is a conceptual diagram that shows one constitutive example of the content information table 200 according to the third exemplary embodiment. In FIG. 14, the cache memory available capacity threshold value A205 is set to 4 Gigabytes, and the cache memory available capacity threshold value B206 is set to 2 Gigabytes. That is to say, in the case of distributing the content in which the content ID is “CID001”, when the available capacity of the cache holding unit 104 falls below 4 Gigabytes that is set by the cache memory available capacity threshold value A205, the file of 1 Mbps with a classification 204 of “low” is read out and stored in the cache holding unit 104 to be distributed. Also, when the available capacity of the cache holding unit 104 falls below 2 Gigabytes that is set by the cache memory available capacity threshold value B206, the file of 1 Mbps with a classification 204 of “low” is read out, and the content that is read out from the content holding unit 103 is directly distributed without storing in the cache holding unit 104.

Next, the operation of distributing content according to the third exemplary embodiment shall be distributed.

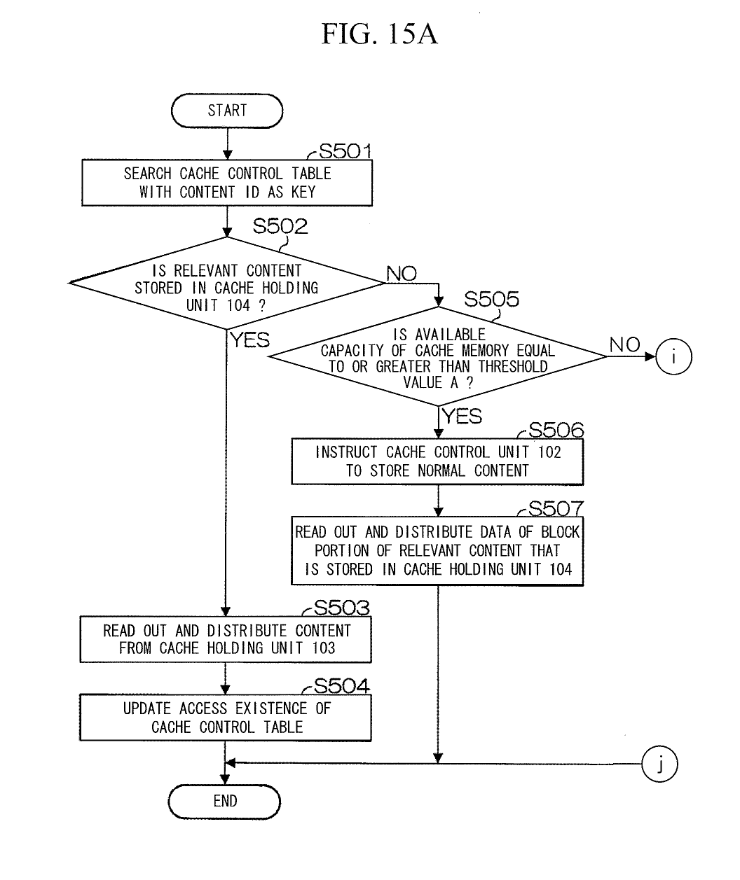

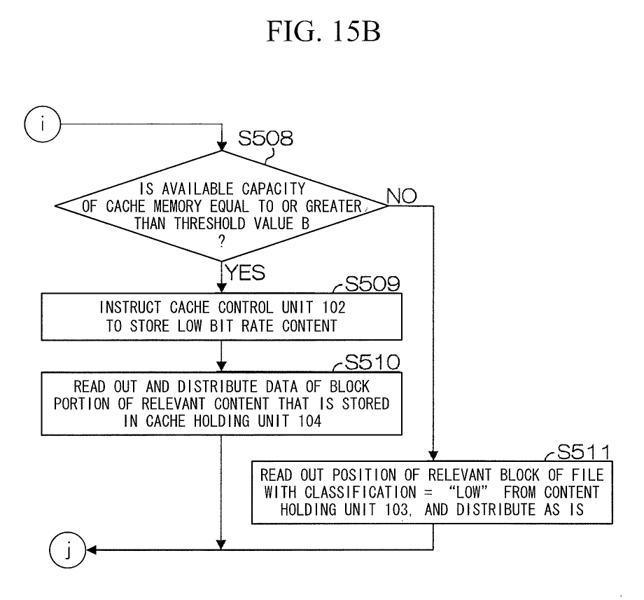

FIGS. 15A and 15B are flowcharts for describing the operation of distributing content according to the third exemplary embodiment. The content distribution unit 101 of the content distribution device 10, upon receiving a content distribution request from the client terminal 201a, searches the cache control table 300 in the content/cache information holding unit 105, with the content ID that is specified for distribution and the playback location serving as keys (Step S501). Next, the content distribution unit 101 judges from the information of the cache existence whether or not the block that corresponds to the specified playback location of the requested content is stored in the cache holding unit 104 (Step S502).

In the case of the data of the block portion of the content being stored in the cache holding unit 104 (that is to say, in the case of the cache existence being “present”), the content distribution unit 101 reads out the data of the block portion of the relevant content from the cache holding unit 104, and distributes that data to the client terminals 201a to 201c (Step S503). Thereafter, if the access existence 305 of the block that belongs to the content of the cache control table 300 in the content/cache information holding unit 105 is “absent”, the content distribution unit 101 updates it to “present”.

On the other hand, in the case of the data of the block portion of the relevant content not being stored in the cache holding unit 104 (that is to say, in the case of the cache existence being “absent”), the content distribution unit 101 judges whether or not the available capacity of the cache memory is equal to or greater than the cache memory available capacity threshold value A that has been set (Step S505). If the available capacity of the cache memory is equal to or greater than the cache memory available capacity threshold value A of the content information table 200, the content distribution unit 101 instructs the cache control unit 102 to store the data of the block portion of the relevant content in the cache holding unit 104 (Step S506). Then, the content distribution unit 101 reads out the data of the block portion of the relevant content that is stored in the cache holding unit 104 by the instruction of Step S506, and distributes that data to the client terminal 201a (Step S507).

On the other hand, in the case of the available capacity of the cache memory being less than the cache memory available capacity threshold value A, moreover, it judges whether or not the available capacity of the cache memory is greater than or equal to the cache memory available capacity threshold value B (Step S508). If the available capacity of the cache memory is less than the cache memory available capacity threshold value A, and greater than or equal to the cache memory available capacity threshold value B, the content distribution unit 101 selects the file in which the classification of the content is set to “low”, and instructs the cache control unit 102 to store the data of the block portion of the relevant content in the cache holding unit 104 (Step S509). Then, the content distribution unit 101 reads out the data of the block portion of the relevant content that is stored in the cache holding unit 104 by the instruction of Step S509, and distributes it to the client terminal 201a (Step S510).

In the case of the available capacity of the cache memory being less than the cache memory available capacity threshold value B, the content distribution unit 101 selects the file in which the classification of the content is set to “low”, reads out the data of the block portion of the relevant file from the content holding unit 103, and directly distributes that data to the client terminals 201a to 201c without caching to the cache holding unit 104 (Step S510).

According to the aforementioned third exemplary embodiment, by gradually setting the cache memory available capacity threshold value in accordance with the bit rate during distribution of the content, at the point in time of the available capacity of the cache holding unit 104 starting to decrease, by reducing the data amount of the content to be stored in the cache holding unit 104, it is possible to store the cache of more content in the cache holding unit 104, and so it is possible to raise the utilization efficiency of the cache holding unit 104.

### D. Fourth Exemplary Embodiment

Next, a fourth exemplary embodiment of the present invention shall be described.

The constitution of the content distribution system and the content distribution device 10 according to the fourth exemplary embodiment is the same as the constitution of the first exemplary embodiment shown in FIG. 1, and so descriptions thereof shall be omitted.

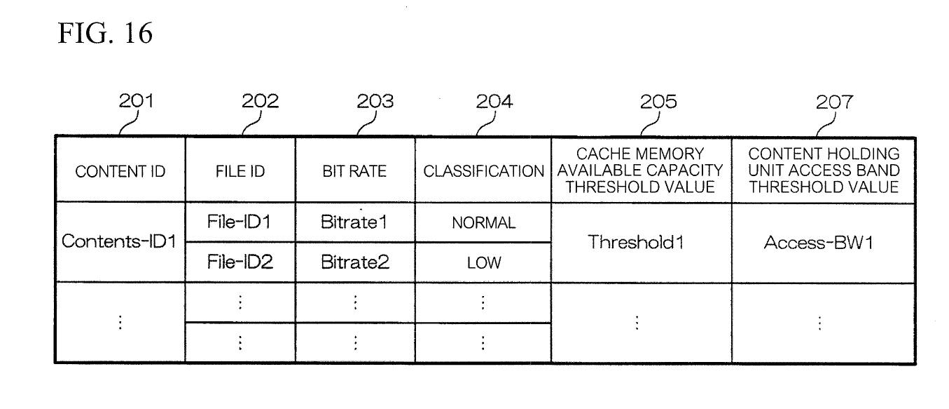

FIG. 16 is a conceptual diagram that shows the constitution of a content information table 200 according to the fourth exemplary embodiment.

The content information table 200 according to the fourth exemplary embodiment differs from the content information table 200 of the first, second and third exemplary embodiments by having a content holding unit access band threshold value 207 in the content information table 200.

A band that sums the band in which the content distribution unit 101 reads out content from the content holding unit 103 in order to distribute the content, and the band in which the cache control unit 102 reads out content from the content holding unit 103 in order to store content in the cache holding unit 104 is set as a content holding unit access band. The content holding unit access band threshold value 207 is a value that is used in the judgment for switching the content to be distributed from the normal distribution bit rate content to the low bit rate content.

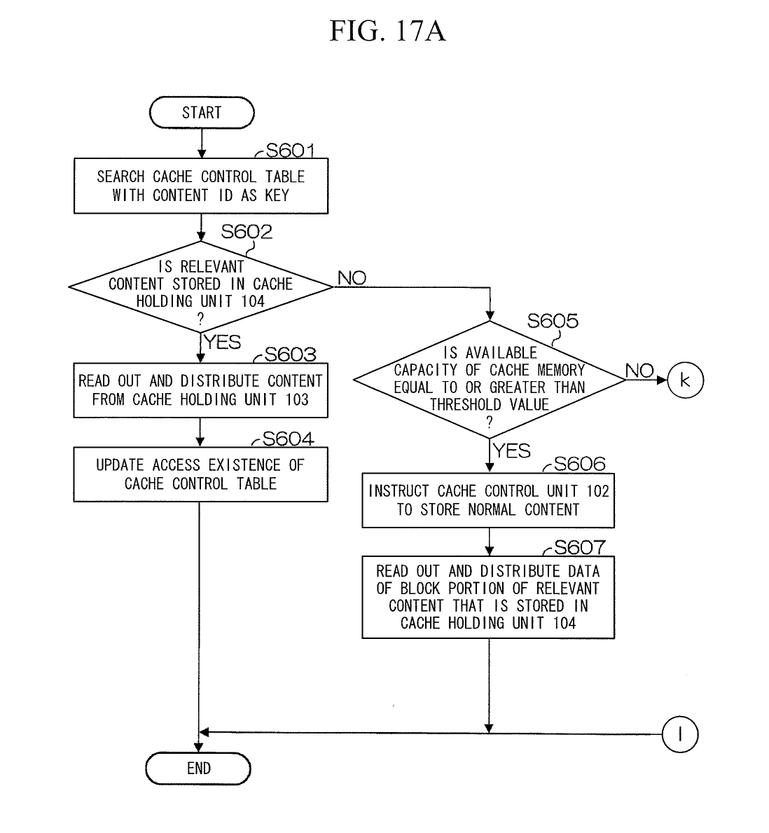

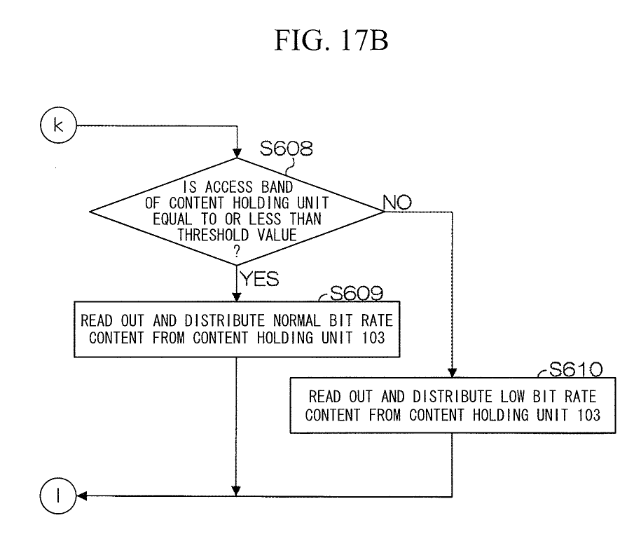

FIGS. 17A and 17B are flowcharts for describing the operation of distributing content according to the fourth exemplary embodiment.

First, the content distribution unit 101 of the content distribution device 10, upon receiving a content distribution request from the client terminals 201a to 201c, searches the cache control table 300 in the content/cache information holding unit 105, with the content ID specified for distribution and the playback location serving as keys (Step S601). Next, the content distribution unit 101 determines from information of the cache existence that is registered corresponding to the block ID whether the block that corresponds to the specified playback location of the requested content is stored in the cache holding unit 104 (Step S602). In the case of the block that corresponds to the specified location of the content being stored in the cache holding unit 104 (that is to say, in the case of the cache existence being “present”), the content distribution unit 101 reads out the data of the block portion of the content from the cache holding unit 104, and distributes that data to the client terminals 201a to 201c (Step S603). Thereafter, if the access existence 305 of the block that belongs to the content of the cache control table 300 in the content/cache information holding unit 105 is “absent”, the content distribution unit 101 updates it to “present” (Step S604).

In the case of the data of the block portion of the relevant data not being stored in the cache holding unit 104 (that is to say, the cache existence is “absent”), the content distribution unit 101 determines whether the available capacity of the cache memory is available by the set threshold value or more (Step S605). If the available capacity of the cache memory is equal to or greater than the cache memory available capacity threshold value 205 of the content information table 200, the content distribution unit 101 instructs the cache control unit 102 to store the data of the block portion of the relevant content in the cache holding unit 104 (Step S606). Then, the content distribution unit 101 reads out the data of the block portion of the relevant content that is stored in the cache holding unit 104 by the instruction of Step S06, and distributes that data to the client terminal 201a (Step S607).

In the case of the available capacity of the cache memory being less than the cache memory available capacity threshold value, a determination is also made as to whether the content holding unit access band is less than or equal to the content holding unit access band threshold value 207 (Step S608). In the case of the content holding unit access band being less than or equal to the content holding unit access band threshold value 207, the content distribution unit 101 selects the file in which the classification of the content is set to “normal”, reads out the data of the block portion of the file from the content holding unit 103, and distributes that data to the client terminal 201a without storing to the cache holding unit 104 (Step S609). On the other hand, in the case of the content holding unit access band being greater than the content holding unit access band threshold value 207, the content distribution unit 101 selects the file in which the classification of the content is set to “low”, reads out the data of the block portion of the file from the content holding unit 103, and distributes that data to the client terminal 201a without storing to the cache holding unit 104 (Step S610).

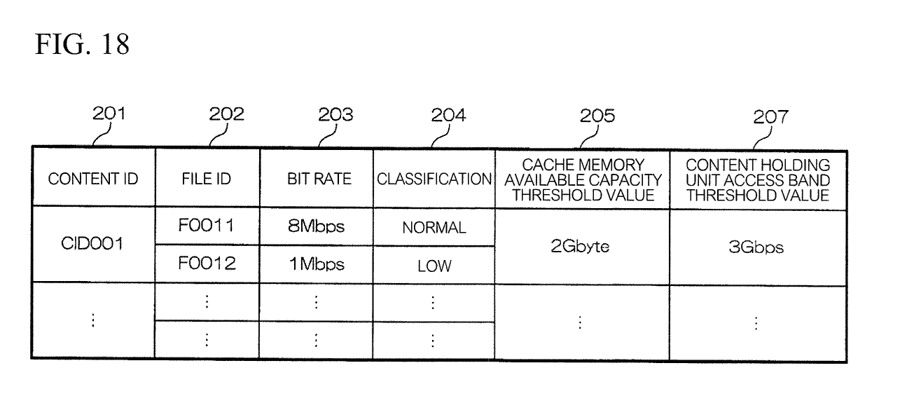

FIG. 18 is a conceptual diagram that shows one constitutive example of the content information table 200 according to the fourth exemplary embodiment.

In the content information table 200 that is shown in FIG. 18, the content holding unit access band threshold value 207 for the content in which the content ID 201 is CID001 is set to 3 Gbps. During distribution of the content of CID001, if the content holding unit access band is equal to or less than 3 Gbps, the content of 8 Mbps that is used in normal distribution is read out and distributed, and in the case of the content holding unit access band exceeding 3 Gbps, the content of 1 Mbps that is the low bit rate content is read out and distributed.

Hereinabove, according to the process of the fourth exemplary embodiment, when deciding the bit rate of the content to be distributed, by considering the access band amount to the content holding unit in addition to the available capacity of the cache memory, even in the case of the available capacity of the cache memory being insufficient, if there is leeway in the access band of the content holding unit, it is possible to distribute content of as high a quality as possible.

A program may cause the content distribution device 10 shown in FIG. 1 to execute a process that distributes content.

Further, the program for implementing the function of the content distribution device 10 shown in FIG. 1 may be stored in a computer-readable recording medium, the program that is recorded on this recording medium may be read and executed by a computer system, and thereby the content distribution device 10 that is shown in FIG. 1 may be made to execute the process of distributing content. The “computer system” described here includes an OS and hardware such as a peripheral device.

If a WWW system is used, the “computer system” includes a homepage providing environment (or a homepage displaying environment).

The “computer-readable recording medium” refers to transportable media such as a flexible disk, a magneto-optical disk, a ROM, and a CD-ROM, and a storage device such as a hard disk that is installed in a computer system. The “computer-readable recording medium” may include one that dynamically maintains a program for a short time period such as a communication line in a case where a the program is transmitted through a network such as the Internet or a communication circuit such a telephone circuit or one that maintains the program for a predetermined time interval such as a volatile memory disposed inside a computer system that serves as a server or a client in such a case. The above-described program may be provided for implementing a portion of the above-described functions, or may be combined with a program that is already recorded in the computer system for implementing the above-described functions.

The present invention has been described with reference to the exemplary embodiments above, but the present invention is not limited to the aforementioned exemplary embodiments. Various modifications that can be understood by a person skilled in the art within the scope of the present invention can be made to the configuration and details of the present invention.

This application is based upon and claims the benefit of priority from Japanese patent application No. 2009-200382, filed Aug. 31, 2009, the disclosure of which is incorporated herein in its entirety by reference.

### INDUSTRIAL APPLICABILITY

The present invention can be applied to uses such as distributing video content such as broadcast programs and movies over a network. The present invention in particular can be applied to a content distribution system that has subscribers on a broad scale that require a high distribution performance and that distributes popular content.

### DESCRIPTION OF REFERENCE SYMBOLS

10 Content distribution device
101 Content distribution unit
102 Cache control unit
103 Content holding unit
104 Cache holding unit
105 Content/cache information holding unit
106 Content registration unit
20 Client group
201a Client terminal
201b Client terminal
201c Client terminal
30 Network

1. A content distribution device comprising:
a content holding unit that holds a plurality of distribution contents that can be distributed, the distribution content including a first content that has a first bit rate and a second content that has a second bit rate lower than the first bit rate;
a cache holding unit that temporarily holds at least one of the first and second contents;
a cache control unit that reads out the first or second content to be distributed from the content holding unit, and stores the read out content in the cache holding unit; and
a content distribution unit that reads out and distributes the first or second content that is temporarily held in the cache holding unit, or the first or second content that is held in the content holding unit, in distribution of a specified content specified by a distribution request among the plurality of distribution contents,
the content distribution unit reading out and distributing the second content of the specified content that is held in the content holding unit, in a case of the specified content not being stored in the cache holding unit, and an available capacity of the cache holding unit being less than a first available capacity threshold value.

2. The content distribution device according to claim 1, wherein the content distribution unit specifies the first available capacity threshold value corresponding to the specified content based on the first available capacity threshold value that is set for each of the plurality of distribution contents, and judges whether the available capacity of the cache holding unit is less than the specified first available capacity threshold value.

3. The content distribution device according to claim 2, wherein the content distribution unit reads out and distributes the second content of the specified content that is held in the content holding unit in a case of the specified content being less than a second available capacity threshold value indicating a value of less than the first available capacity threshold value.

4. The content distribution device according to claim 3, wherein the content distribution unit temporarily holds in the cache holding unit the second content of the specified content that is held in the content holding unit, and reads out and distributes the second content that is temporarily held in the cache holding unit, in a case of the specified content being less than the first available capacity threshold value and equal to or greater the second available capacity threshold value.

5. A content distribution device comprising:
a content holding unit that holds a plurality of distribution contents that can be distributed, the distribution content including a first content that has a first bit rate and a second content that has a second bit rate lower than the first bit rate;
a cache holding unit that temporarily holds at least one of the first and second contents;
a cache control unit that reads out the first or second content to be distributed from the content holding unit, and stores the read out content in the cache holding unit; and
a content distribution unit that reads out and distributes the first or second content that is temporarily held in the cache holding unit, or the first or second content that is held in the content holding unit, in distribution of a specified content specified by a distribution request among the plurality of distribution contents,
the content distribution unit reading out and distributing the second content of the specified content that is held in the content holding unit, in a case of the specified content not being stored in the cache holding unit, and total of access bands in which the cache control unit and the content distribution unit respectively read out the first or second content from the content holding unit being equal to or greater than an access band threshold value.

6. A content distribution method for a content distribution device, the method comprising:
holding in a content holding unit of the content distribution device a plurality of distribution contents that can be distributed, the distribution content including a first content that has a first bit rate and a second content that has a second bit rate lower than the first bit rate;
temporarily holding at least one of the first and second contents in a cache holding unit of the content distribution device;
reading out the first or second content to be distributed from the content holding unit, and storing the read out content in the cache holding unit, by a cache control unit of the content distribution device; and
reading out and distributing the second content of a specified content that is held in the content holding unit by a content distribution unit of the content distribution device, in a case of the specified content that is specified by the distribution request among the plurality of distribution contents not being stored in the cache holding unit, and an available capacity of the cache holding unit being less than a first available capacity threshold value.

7. A content distribution method for a content distribution device, the method comprising:
holding in a content holding unit of the content distribution device a plurality of distribution contents that can be distributed, the distribution content including a first content that has a first bit rate and a second content that has a second bit rate is lower than the first bit rate;
temporarily holding at least one of the first and second contents in a cache holding unit of the content distribution device;
reading out the first or second content to be distributed from the content holding unit, and storing the read out content in the cache holding unit, by a cache control unit of the content distribution device; and
reading out and distributing the second content of a specified content that is held in the content holding unit by a content distribution unit of the content distribution device, in a case of a specified content specified by the distribution request among the plurality of distribution contents not being stored in the cache holding unit, and total of access bands in which the cache control unit and the content distribution unit respectively read out the first or second content from the content holding unit being equal to or greater than an access band threshold value.

8. A computer-readable recording medium storing a program for a computer of a content distribution device, the device comprising:
a content holding unit that holds a plurality of distribution contents that can be distributed, the distribution content including a first content that has a first bit rate and a second content that has a second bit rate lower than the first bit rate; and
a cache holding unit that temporarily holds at least one of the first and second contents,
the program causing the computer to function as:
a cache control unit that reads out the first or second content to be distributed from the content holding unit, and stores the read out content in the cache holding unit; and
a content distribution unit that reads out and distributes the second content of a specified content that is held in the content holding unit in a case of a specified content that is specified by the distribution request among the plurality of distribution contents not being stored in the cache holding unit, and an available capacity of the cache holding unit being less than a first available capacity threshold value.

9. A computer-readable recording medium storing a program for a computer of a content distribution device, the device comprising:
a content holding unit that holds a plurality of distribution contents that can be distributed, the distribution content including a first content that has a first bit rate and a second content that has a second bit rate lower than the first bit rate; and
a cache holding unit that temporarily holds at least one of the first and second contents,
the program causing the computer to function as:
a cache control unit that reads out the first or second content to be distributed from the content holding unit, and stores the read out content in the cache holding unit; and
a content distribution unit that reads out and distributes the second content of a specified content that is held in the content holding unit, in a case of the specified content that is specified by the distribution request among the plurality of distribution contents not being stored in the cache holding unit, and total of access bands in which the cache control unit and the content distribution unit respectively read out the first or second content from the content holding unit being equal to or greater than an access band threshold value.
